(19) United States
(12) Patent Application Publication
(10) Pub. No.: US 2002/0095375 A1
(43) Pub. Date: Jul. 18, 2002

(54) Communication method, electronic commercial transaction method, managing apparatus and virtual city space

(75) Inventors: Kazutomi Taneda, Kawasaki (JP); Takeo Fujita, Kawasaki (JP); Daisuke Takahashi, Kawasaki (JP); Kiyoshi Kuwakawa, Higashine (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/046,498

(22) Filed: Jan. 16, 2002

(30) Foreign Application Priority Data
Jan. 17, 2001 (JP) 2001-009132

(51) Int. Cl. G06F 17/60

(52) U.S. Cl. 705/39

(57) ABSTRACT

A communication method involves communicating via a network virtual personal information having a representation format similar to that of real personal information of a real world, and converting the virtual personal information into the real personal information based on registered information, in a managing apparatus provided in the network.

### BACKGROUND OF THE INVENTION

This application claims the benefit of a Japanese Patent Application No. 2001-009132 filed Jan. 17, 2001, in the Japanese Patent Office, the disclosure of which is hereby incorporated by reference.

1. Field of the Invention

The present invention generally relates to communication methods, electronic commercial transaction methods, managing apparatuses, and virtual city spaces, and more particularly to a communication method and an electronic commercial transaction method which communicate via a network, a managing apparatus which manages communications and electronic commercial transactions made via a network, and a virtual city space for use by such a communication method and electronic commercial transaction method.

In this specification, communications and electronic commercial transactions include various kinds of contents services, including as electronic commercial transactions via a network such as the Internet, debit card settlements (settlements of accounts), Internet telephones, information distribution services and the like.

Presently, when making a commercial transaction via a network such as the Internet, it is difficult to completely protect personal information communicated via the network, such as names, addresses and telephone numbers of individuals, and credit card numbers of credit cards owned by the individuals. For this reason, there is a possibility that the personal information will be misused by third parties when the commercial transaction is made via the network, and actual damages have been reported. This is one obstacle in making the commercial transaction via the Internet popular.

2. Description of the Related Art

Conventionally, when making an electronic commercial transaction between an individual and a corporation, for example, there is a method which provides a homepage of the corporation on the Internet. On the Web, the individual can make an order after reading a description of a product or seeing a picture or the like of the product the individual wishes to purchase. In this case, the electronic commercial transaction is basically approximately the same as a mail order transaction, except that the electronic commercial transaction can successively update the description, photographs and the like of the products, the cost of using the electronic commercial transaction is inexpensive, and the order can be made quicker than the mail order. In other words, a customer who uses the electronic commercial transaction must also send the customer's real name and address via the Internet to the other party who is selling the product. If a credit card is used for the payment, the customer must also send the credit card number via the Internet to the other party. Furthermore, when making an electronic commercial transaction between two individuals, such as in an auction, it is also necessary for each individual to reveal the name and address to the other.

Accordingly, in the existing electronic commercial transaction made via the Internet between two parties, it is impossible for the two parties to make the transaction anonymously. For this reason, there is a possibility that the personal information communicated via the Internet may be intercepted and misused by a third party.

On the other hand, in the existing communication made via a network, an enciphering technique is mainly used to provide security. In other words, when transmitting data such as the personal information, the data is enciphered before the transmission, so that it is difficult to decode the data when intercepted by a third party. In this case, however, regardless of whether the data intercepted by the third party is actually decodable or not, the data is communicated via the network. Accordingly, there is still a possibility that the data communicated via the network will be intercepted and decoded by the third party, if the decoding ease of the enciphered data is not taken into consideration. Moreover, according to the enciphering technique, an enciphering process must be carried out at a transmitting end, and a deciphering or decoding process must be carried out at a receiving end. In addition, the transmitting end and the receiving end must employ the same enciphering technique. Consequently, the environment in which the enciphering technique may be used becomes limited.

Methods which employ the so-called call-back system have also been proposed in corporate networks and the like, as countermeasures for preventing unauthorized access to the networks. According to such methods, the corporation automatically calls back the telephone number of the user only when it is necessary to acquire the user's personal information such as when making a commercial transaction. In this case, the user can send the personal information to the corporation using a public line. Hence, the personal information will not be communicated via the network in this case, but the user can only make access to the corporation under a specific environment which enables the call-back, thereby limiting the access from the user. In other words, when the user makes access to the corporation from a location having a telephone number other than the telephone number which is registered in advance at the corporation, the corporation cannot confirm the user by the call-back.

Therefore, the conventional methods and systems have problems in that it is impossible to make the communication and the electronic commercial transaction anonymously, there is a possibility that the personal information communicated via the network will be intercepted and misused by a third party, and the environment in which the service may be used and the access to the service may become limited if an attempt is made to improve the security.

### SUMMARY OF THE INVENTION

Accordingly, it is a general object of the present invention to provide a novel and useful communication method, electronic commercial transaction method, managing apparatus, and virtual city space, in which the problems described above are eliminated.

Another and more specific object of the present invention is to provide a communication method, an electronic commercial transaction method, a managing apparatus, and a virtual city space, which enable a communication and an electronic commercial transaction without having to communicate personal information via a network, and enable improved security without limiting an environment in which a service may be used or limiting an access to the service.

Still another object of the present invention is to provide a communication method comprising the steps of communicating via a network virtual personal information having a representation format similar to that of real personal information of a real world; and converting the virtual personal information into the real personal information based on registered information, in a managing apparatus provided in the network. According to the communication method of the present invention, it is possible to prevent interception and misuse of the real personal information on the network because the communication can be made anonymously using the virtual personal information. In addition, it is possible to improve the security without limiting the environment in which the communication is made or restricting the access.

A further object of the present invention is to provide an electronic commercial transaction method comprising the step of making a commercial transaction in a virtual world on a network, based on virtual personal information received via the network, where the virtual personal information has a representation format similar to that of real personal information of a real world. According to the electronic commercial transaction method of the present invention, it is possible to prevent interception and misuse of the real personal information on the network because the commercial transaction can be made anonymously using the virtual personal information. In addition, it is possible to improve the security without limiting the environment in which the commercial transaction is made or restricting the access.

Another object of the present invention is to provide a managing apparatus comprising managing means for managing registered information which is used when converting virtual personal information into real personal information of a real world, the virtual personal information having a representation format similar to that of the real personal information; and converting means for converting the virtual personal information received via a network into corresponding real personal information of the real world, based on the registered information. According to the managing apparatus of the present invention, it is possible to prevent interception and misuse of the real personal information on the network because the communication or commercial transaction can be made anonymously using the virtual personal information. In addition, it is possible to improve the security without limiting the environment in which the communication or commercial transaction is made or restricting the access.

Still another object of the present invention is to provide a virtual city space comprising a plurality of virtual shops accessible via a network, where a commercial transaction is made between a first virtual individual and an arbitrary one of the virtual shops, based on virtual personal information of the first virtual individual, and the virtual personal information has a representation format similar to that of real personal information of a real world. According to the virtual city space of the present invention, it is possible to prevent interception and misuse of the real personal information on the network because the communication or commercial transaction can be made anonymously using the virtual personal information. In addition, it is possible to improve the security without limiting the environment in which the communication or commercial transaction is made or restricting the access.

Other objects and further features of the present invention will be apparent from the following detailed description when read in conjunction with the accompanying drawings.

### BRIEF DESCRIPTION OF THE DRAWINGS

FIG. 1 is a system block diagram for explaining the operating principle of the present invention;

FIG. 2 is a diagram for explaining a conversion table;

FIG. 3 is a system block diagram showing a first embodiment of a managing apparatus according to the present invention;

FIG. 4 is a flow chart for explaining a first settlement method;

FIG. 5 is a flow chart for explaining a second settlement method;

FIG. 6 is a flow chart for explaining a third settlement method;

FIG. 7 is a flow chart for explaining a fourth settlement method;

FIG. 8 is a diagram showing a three-dimensional display format of a virtual city;

FIG. 9 is a diagram showing a two-dimensional display format of a virtual city;

FIG. 10 is a flow chart for explaining the operation of the first embodiment;

FIG. 11 is a diagram for explaining a second embodiment of an electronic commercial transaction method according to the present invention; and

FIG. 12 is a diagram for explaining a third embodiment of a communication method according to the present invention.

### DESCRIPTION OF THE PREFERRED EMBODIMENTS

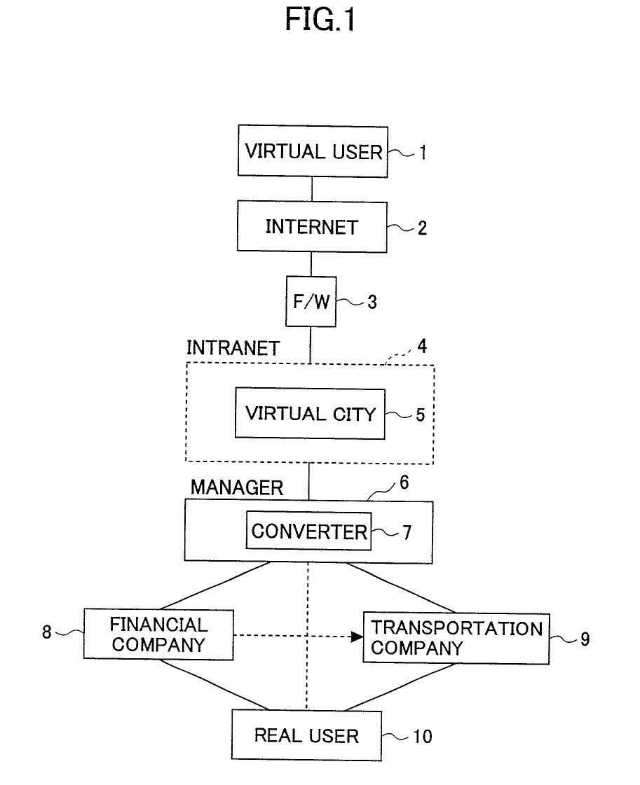

First, a description will be given of the operating principle of the present invention, by referring to FIG. 1. FIG. 1 is a system block diagram for explaining the operating principle of the present invention. In the present invention, each user acts as a virtual individual within a virtual world, so that communications and electronic commercial transactions can be made anonymously. It is assumed for the sake of convenience that a real (or actual) user 10 acts as a virtual user 1 within the virtual world.

In FIG. 1, the real user 10 registers in advance personal information of the real user 10 in the real world (hereinafter referred to as real personal information) and virtual personal information of the virtual user 1, to a manager (managing apparatus) 6. The virtual personal information includes a virtual name, a virtual address within a virtual city (or virtual city space) within the virtual world, a virtual telephone number, a virtual account number of a virtual bank within the virtual city, a virtual credit card number of a virtual credit card used in the virtual world and the like, which respectively correspond to a real address within a real city (or real city space) within the real world, a real telephone number, a real account number of a real bank within the real city, a real credit card number of a real credit card used in the real world and the like. A log-in password of the virtual user 1, a transaction password of the virtual user 1, a bank transaction personal identification (ID) number of the virtual user 1, a personal ID number of the virtual credit card of the virtual user 1 and the like may also be registered as the virtual personal information if necessary. Therefore, the virtual personal information has properties different from the properties of an ID, user password or the like which are used when accessing a specific site on the Internet, for example, because the virtual personal information has a representation format similar to that of the real personal information.

There are the following two basic reasons for registering the virtual personal information within the virtual world. The first reason for registering the virtual personal information is to avoid problems which are generated when each user uses within the virtual world a name different from the real name. From the point of view of making a transaction, the virtual personal information other than the virtual name (or virtual transaction ID) is not essential for at least realizing the present invention. However, when the virtual personal information consists solely of the virtual name, users having the same virtual name within the virtual world cannot be distinguished, and in this case, all of the virtual names must be different in order to be able to distinguish all of the users. On the other hand, when the virtual address is also included in the virtual personal information, for example, even if the system becomes large and the virtual name desired by one user is the same as the virtual name desired by another user, it is still possible to distinguish the users having the same virtual name from the virtual addresses of the users. In other words, by also including the virtual personal information which is other than the virtual name in the virtual personal information, it becomes possible to distinguish each user based on the virtual personal information other than the virtual name.

The second reason for registering the virtual personal information is to avoid problems when making a transaction within the virtual world. For example, when opening a virtual shop within the virtual world, it is necessary to provide information which indicates the location of the virtual shop. In the electronic commercial transaction within the real world, it is possible to indicate the location of the shop by the URL. Accordingly, the location of the virtual shop within the virtual world can be indicated similarly by the URL, but this would require each user to prepare a homepage. In addition, from the point of view of the manager, it is difficult to check the contents of the homepage of each user. On the other hand, when a basic Web region is prepared in advance by the manager and unified virtual addresses are issued for each virtual city, it is possible to eliminate such problems. Furthermore, when providing a telephone service or the like using the Internet, it is more convenient to have the virtual personal information other than the virtual name.

The virtual user 1 uses the virtual personal information and accesses a virtual city 5 on the Web, via a network such as the Internet 2. For example, the access to the virtual city 5 can be made by inputting “manager name @ virtual city name”. Accordingly, if the manager name is ABC and the virtual city name is DEF, the access to the virtual city 5 can be made by inputting “ABC@DEF”.

The virtual city 5 is provided on an intranet 4 which is connected to the Internet 2 via a firewall (F/W) 3, for example. Virtual houses, virtual shops, virtual banks and the like which are similar to those of the real city, exist within the virtual city 5. When the virtual user 1 purchases an item in the virtual shop within the virtual city 5, information related to the purchase of this item is notified to a manager 6 together with the virtual personal information of the virtual user 1. The item may be purchased by a withdrawal from a virtual bank account or by use of a virtual credit card, and thus, the information related to the purchase of the item includes the virtual bank account number or the virtual credit card number. The virtual user 1 (real user 10) can remit an arbitrary amount of money to the virtual bank account via the manager 6, and withdraw virtual money from the virtual bank account within a range not exceeding the balance, so as to use the virtual money similarly to electronic money. In addition, it is possible to make arrangements so that an amount of money corresponding to the amount of virtual money withdrawn from the virtual bank account is automatically withdrawn from the corresponding real bank account of the real user 10.

Before making the settlement related to the purchase of the item by the virtual user 1, it is desirable to confirm that the virtual user 1 is the real user 10 for security purposes. In this case, the method of confirmation is not limited to a specific method. For example, an authentication number or a password which is to be input by the real user 10 when approving the settlement may be registered in advance to the manager 6, and the manager 6 may require the real user 10 to input the authentication number or password via the Internet or telephone when requiring the approval of the settlement. In addition, the approval of the settlement may be required only under predetermined conditions, such as when the settlement amount is greater than a predetermined amount or exceeds the balance of the virtual bank account.

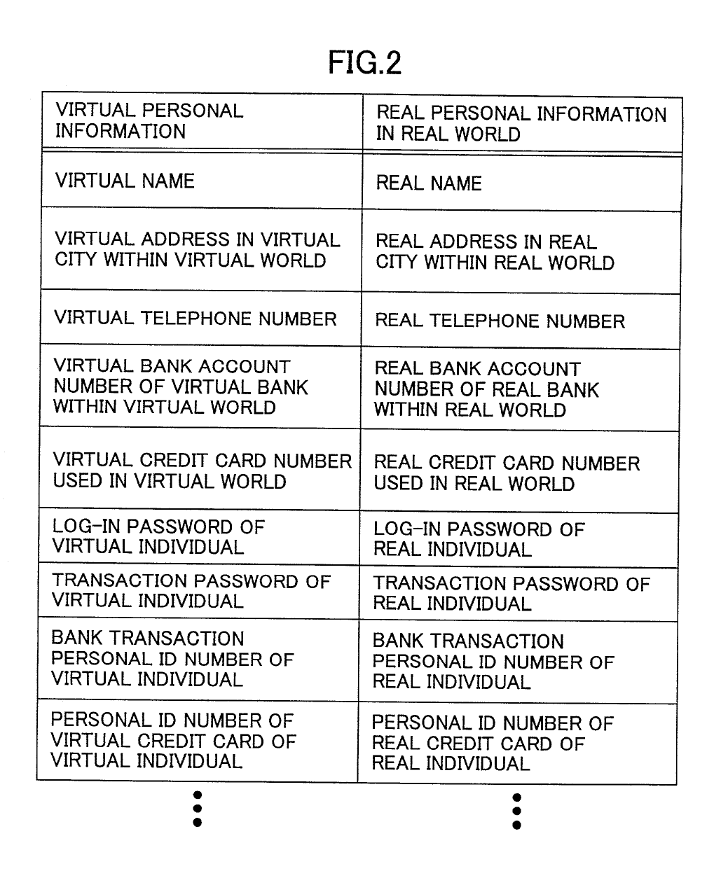

The manager 6 manages registered information which is necessary to convert the virtual personal information into the real personal information. A converter 7 within the manager 6 converts the virtual personal information into the real personal information based on the registered information. The registered information may take the form of a conversion table shown in FIG. 2. In addition, the manager 6 notifies the real personal information and the charge of the cost related to the purchase of the item to a financial company (or financial business) 8 such as a bank and a credit card company, and the charge is made from the financial company 8 to the real user 10. The real personal information notified from the manager 6 to the financial company 8 after approval of the settlement includes the real name of the individual (real user 10), the real bank account number, the real credit card number and the like. On the other hand, a transportation company (or the post office) 9 delivers the purchased item based on the real personal information which is notified from the manager 6 after approval of the settlement. The virtual shop sends the purchased item to the transportation company 9 when a notification is received from the manager 6 confirming the approval of the settlement. The real personal information which is notified from the manager 6 to the transportation company 9 includes the real name of the individual (real user 10), the real address of the real user 10, the real telephone number of the real user 10 and the like. The item itself may be sent directly to the transportation company 9 from an organization or the like which provides the virtual city 5, or via the manager 6.

The intranet 4 and the virtual city 5 may be provided within the manager 6 or, provided independently outside the manager 6. In other words, the virtual city 5 may be provided by an organization (or company) independent from the manager 6 but tied up with the manager 6 or, may be provided by the manager 6. In addition, the financial company 8 and the transportation company 9 may respectively be organizations which are independent of the virtual city and/or the manager 6 or, the same organization. Moreover, if the security can be maintained, the converter 7 may be provided in the financial company 8 and/or the transportation company 9.

The method of communication between the virtual city 5 and the manager 6, the method of communication between the manager 6 and the financial company 8, the method of communication between the manager 6 and the transportation company 9, the method of communication between the financial company 8 and the real user 10, and the method of communication between the transportation company 9 and the real user 10 are not limited to specific communication methods.

The virtual user 1 does not have to make an electronic commercial transaction in the virtual city 5, and may simply communicate with another virtual individual (virtual user) having a virtual house at a virtual address within the virtual city 5. In addition, the communications or electronic commercial transactions may be made among a plurality of virtual cities.

Further, after the settlement related to the purchase of the item is approved, the transportation company 9 may deliver the purchased item in response to a notification from the financial company 8.

Therefore, according to the present invention, the real personal information will not be communicated via the network such as the Internet, and only the virtual personal information is communicated via the network. For this reason, it is possible to make the communication and the electronic commercial transaction anonymously. For example, even if the virtual personal information is intercepted by a third party, the information which links the virtual personal information to the real personal information is managed by the manager (and also by the financial company and/or the transportation company in some cases), and this information cannot be acquired by the third party. Hence, there is no possibility of the real personal information being intercepted and misused by the third party. In addition, because the access to the virtual world is made using the virtual personal information, it is possible to improve the security without limiting the environment in which the access may be made or restricting the access itself. Accordingly, the electronic commercial transaction in the virtual city in particular can be made using only the virtual personal information, that is, anonymously without the need to reveal the real personal information, as if actually shopping in a shop in the real city. The electronic commercial transaction may also be applied to a so-called net-auction which holds an auction over a network such as the Internet.

The security can further be improved by employing a known enciphering technique for the communication between the virtual individual and the virtual world. If the virtual personal information in the virtual world is somehow misused by a third party, the virtual personal information can easily be changed, unlike the real personal information which cannot be changed easily. In the real world, one cannot simply move to another location in order to change the address. But in the virtual world such as the virtual city, one can simply and easily change the virtual address. The virtual personal information is registered to the manager and the manager can monitor the misuse of the virtual personal information, so as to prevent unauthorized or illegal acts and further improve the security.

From the point of view of improving the security, it is desirable that the virtual city is provided on the intranet within the managing apparatus which is operated by the manager. However, it is not essential to provide the virtual city on the intranet. In other words, the network on which the virtual city is provided simply needs to be connected to the Internet via the firewall, to enable mutual access between the network and an external network. A known authentication technique may be employed when making the access. In addition, as long as the user is registered to the manager, the user is not limited to making the access from a terminal exclusively for the user, and the user may access the virtual world not only from a limited environment but also from any environment in which the Internet is usable. As a result, by providing an Internet terminal at locations such as a station, a supermarket and a hotel, it becomes easier and convenient for the user to make the communication or electronic commercial transaction using the virtual world. If a plurality of virtual cities are provided, it is possible to make exchanges among the virtual cities, and such exchanges can also be made among virtual cities provided in different countries.

Various forms of communications are possible using the virtual world. For example, by using the virtual telephone number of the virtual individual, it is possible to provide a service which enables a voice communication using the Internet. If the virtual individual at a connecting destination has an on-line connection, it is possible to make a voice communication by specifying the virtual telephone number of the connecting destination. The present invention may be also applied to counseling and various forums. In addition, by employing a high-speed communication using a cable television line, ADSL or the like, the present invention can also be applied to music distribution services, video distribution services, and language teaching services using voice communication, in addition to the existing contents presently available on the Internet.

Next, a description will be given of a first embodiment of an electronic commercial transaction method according to the present invention. This first embodiment of the electronic commercial transaction method employs a first embodiment of a communication method according to the present invention and a first embodiment of a managing apparatus according to the present invention.

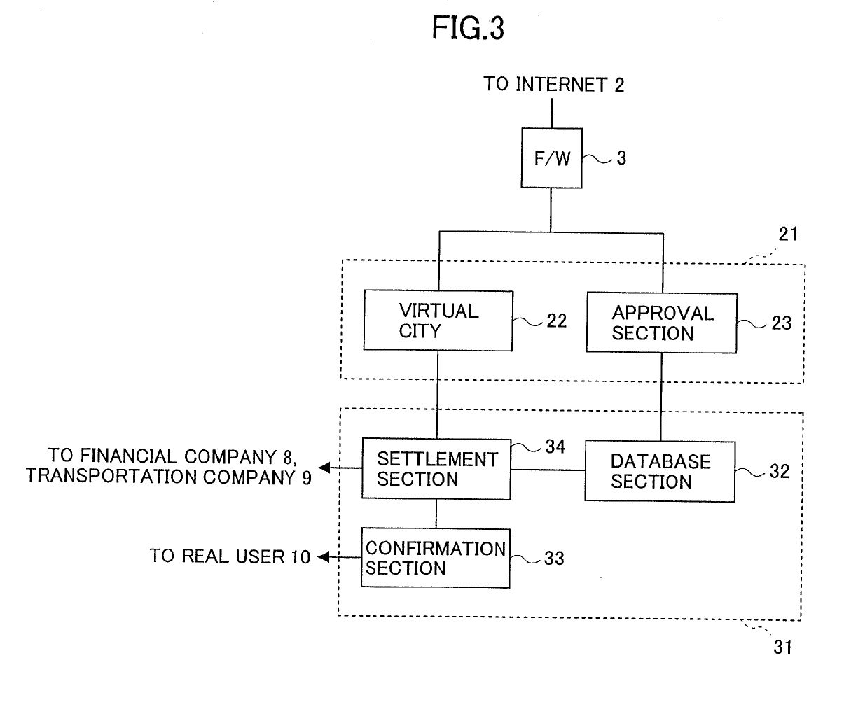

FIG. 3 is a system block diagram showing this first embodiment of the managing apparatus according to the present invention. In FIG. 3, those parts which are the same as those corresponding parts in FIG. 1 are designated by the same reference numerals, and a description thereof will be omitted.

A server system 31 shown in FIG. 3 forms a managing apparatus of the manager 6 shown in FIG. 1. The server system 31 is connected to a server system 21 which is provided on the intranet 4 shown in FIG. 1 and provides the virtual city 5. Each of the server systems 31 and 21 has a known hardware structure similar to that of a computer system.

The server system 31 includes a database section 32, a confirmation section 33 and a settlement section 34 which are functional sections. The server system 21 includes a virtual city section 22 and an approval section 23 which are functional sections. In a case where the manager 6 provides the virtual city 5, the server systems 31 and 21 may be formed by a single server system.

In the server system 31, the database section 32 manages a database related to the users. The database managed by the database section 32 includes registered information which is necessary to convert the virtual personal information of the virtual user 1 to the real personal information of the real user 10, the real personal information of the real user 10, the amount of money used by (purchased amount of) the real user 10 and the like. The registered information may take the form of the conversion table shown in FIG. 2. The confirmation section 33 carries out a confirmation process to confirm the approval of the settlement. More particularly, the confirmation section 33 automatically confirms the approval of the settlement by telephone, letter, electronic mail (e-mail) or the like, depending on the method specified by the virtual user 1. The settlement section 34 carries out a data processing to process the data received from the virtual user 1. When the virtual user 1 purchases an item, the settlement section 34 notifies the information related to the purchase of this item to the confirmation section 33. In a case where the amount of purchase is small and there is no need to confirm the approval of the settlement or, the approval of the settlement is confirmed, the virtual personal information, the amount of money used, and the like are transferred from the settlement section 34 to the database section 32. As a result, the database section 32 converts the virtual personal information into the real personal information based on the registered information, and the real personal information and the information related to the purchase, including the amount of purchase, are notified to the financial company 8 and the transportation company 9 via the settlement section 34. In addition, when the approval of the settlement is confirmed, this confirmation is notified from the confirmation section 33 to the server system 21, to thereby notify the virtual shop within the virtual city 5 where the virtual user 1 purchased the item.

If the item is to be sent to the real user 10 by cash-on-delivery, the virtual user 1 can specify the cash-on-delivery at the time of the purchase. In this case, no notification from the settlement section 34 to the financial company 8 is necessary.

If the security can be maintained, the registered information may be managed by the financial company 8 and/or the transportation company 9, so that the conversion of the virtual personal information into the real personal information is made at the financial company 8 and/or the transportation company 9. In this case, even if the manager 6 communicates with the financial company 8 and/or the transportation company 9 via the Internet, the virtual personal information and not the real personal information is communicated via the Internet. For this reason, there is no possibility of the real personal information being intercepted on the Internet by a third party.

Next, a description will be given of first through fourth settlement methods.

### First Settlement Method

According to the first settlement method for a case where a transaction is made within the virtual city 5, the information of the virtual world is converted into the information of the real (actual) world outside the network in which the virtual city 5 is provided. The security is maintained by obtaining confirmation from the real user 10 when the manager 6 (or the financial company 8 and/or transportation company 9) converts the virtual credit card number or the virtual bank account number into the real credit card number or the real bank account number.

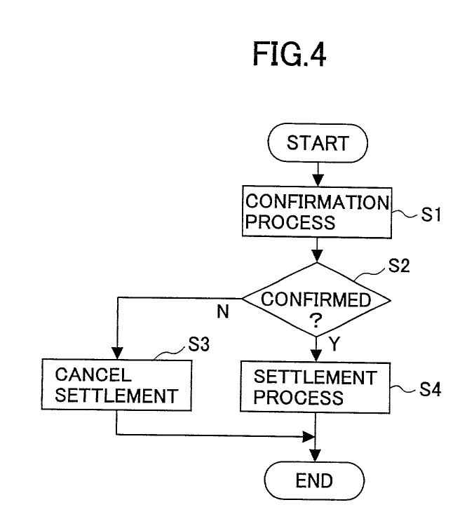

FIG. 4 is a flow chart for explaining the first settlement method. In FIG. 4, a step S1 seeks confirmation from the real user 10. This confirmation may be sought by telephone, mail or the like. It is possible make this confirmation by electronic mail, but from the point of view of security, it is possible to provide higher security by making the confirmation by telephone or mail. This is because, it is difficult for a third party to pose as the real user 10 who made the transaction, when the confirmation is made by telephone or mail. By using a portable telephone or the like as the destination to be contacted for the confirmation, it is possible to make the confirmation quickly and to maintain a high security. For example, it is possible to considerably increase the speed of the settlement by introducing a system which automatically calls the portable telephone from the settlement section 34 when making the settlement and converting the virtual personal information into the real personal information.

A step S2 decides whether or not the confirmation is obtained from the real user 10. If the decision result in the step S2 is NO, a step S3 cancels the settlement, and the process ends. On the other hand, if the decision result in the step S2 is YES, a step S4 carries out the settlement process, and the process ends.

### Second Settlement Method

According to the first settlement method, it is possible to maintain a high security, but it takes time to make the settlement due to the confirmation process. Accordingly, the second settlement method makes the settlement by directly using the virtual bank account or the virtual credit card within the virtual city 5, in order to speed up the settlement.

By making a deposit to the virtual bank account within the virtual city 5 from the real bank account, the virtual money in the virtual bank account may be used for the settlement within the virtual city 5 as a kind of electronic money. In this case, there is a possibility of the virtual bank account number or the like being intercepted on the Internet 2 by a third party, and for this reason, it is desirable to carry out an enciphering process on the virtual bank account number or the like at the time of the communication. The settlement within the virtual city 5 using the virtual credit card may be made similarly to the case where the virtual bank account is used. It is also desirable to carry out an enciphering process on the virtual credit card number or the like at the time of the communication.

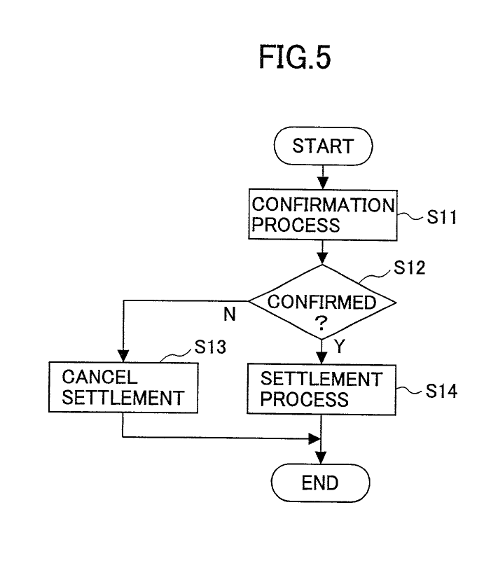

FIG. 5 is a flow chart for explaining the second settlement method. In FIG. 5, a step S11 seeks confirmation from the real user 10 on the settlement using the virtual bank account, based on the bank transaction personal ID number, the balance or the like of the virtual bank account of the virtual user 1 or, on the settlement using the virtual credit card based on the personal ID number, the upper limit amount of transaction or the like of the virtual credit card of the virtual user 1. A step S12 decides whether or not the confirmation is obtained from the real user 10. If the decision result in the step S12 is NO, a step S13 cancels the settlement, and the process ends. On the other hand, if the decision result in the step S12 is YES, a step S14 carries out a settlement process, and the process ends.

### Third Settlement Method

By providing a remittance service to enable remittance to the virtual bank account within the virtual city 5, it is possible to make a remittance from one individual to another individual without knowing the real name or the real bank account number of the other individual. The first and second settlement methods described above take into consideration the transaction between the virtual user 1 and the virtual shop within the virtual city 5. But when the transaction is made between the virtual users within the virtual city 5, as in the case of an auction, it is also possible to employ the first or second settlement method. When a process similar to that of the first or second settlement method is employed primarily by the virtual user 1 who makes the payment, it is possible to remit from a first virtual bank account to a second virtual bank account, while maintaining the security.

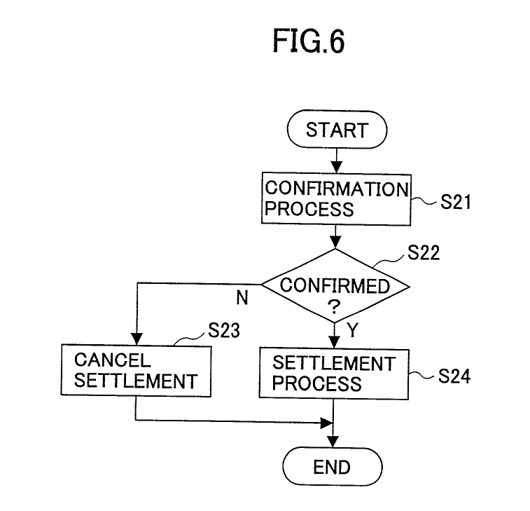

FIG. 6 is a flow chart for explaining the third settlement method. In FIG. 6, a step S21 seeks confirmation from the real user 10 on the settlement using the virtual bank account of the virtual user 1 who is to make the payment, based on the bank transaction personal ID number, balance or the like of this virtual user 1 or, based on the personal ID number, the upper limit amount of transaction or the like of the virtual credit card of the virtual user 1 who is to make the payment. A step S22 decides whether or not the confirmation is obtained from the real user 10. If the decision result in the step S22 is NO, a step S23 cancels the settlement, and the process ends. On the other hand, if the decision result in the step S22 is YES, a step S24 carries out a settlement process to remit or pay from the virtual user 1 who is to make the payment to the virtual user who is to receive the payment, and the process ends.

### Fourth Settlement Method

According to the fourth settlement method, the first or second settlement method is selectively employed depending on a predetermined condition. The predetermined condition may be (i) the amount of money or, (ii) specified from the virtual user 1. In the former case (i), it is possible to set the amount of money to 100 dollars, for example. In this case, a confirmation may be required by telephone, mail or the like to approve the settlement of a transaction of 100 dollars or more, while no confirmation to approve the settlement is required for a transaction of less than 100 dollars, so that the settlement may be made similarly as in the case of the conventional credit card settlement or the conventional electronic money settlement. In this case, it is possible to immediately pay the charge when acquiring relatively inexpensive charged contents on the network, for example, so that the charged contents can be acquired immediately, while the confirmation on the approval of the settlement is only required when acquiring a relatively expensive charged contents or items. On the other hand, in the latter case (ii), the virtual user 1 can specify in advance whether the first settlement method is to be used, the second settlement method is to be used or, both the first and second settlement methods are to be used.

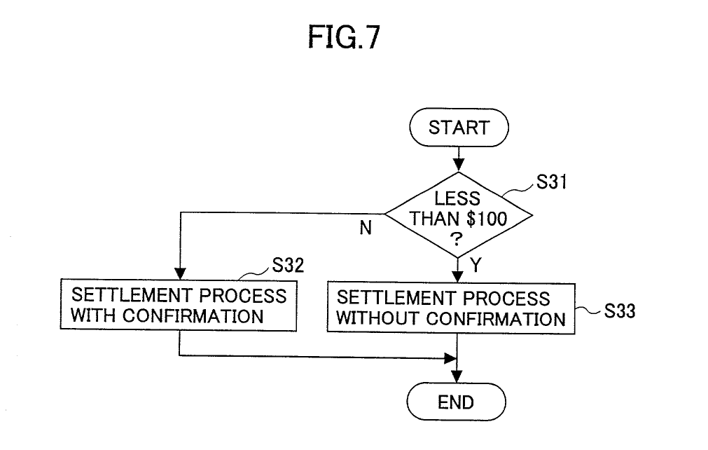

FIG. 7 is a flow chart for explaining the fourth settlement method. In FIG. 7, a step S31 decides whether or not the transaction is less than a predetermined amount such as 100 dollars. If the decision result in the step S31 is NO, a step S32 carries out a settlement process which includes obtaining confirmation from the real user 10, similarly to any one of the first through third settlement methods described above, and the process ends. On the other hand, if the decision result in the step S31 is YES, a step S33 carries out a settlement process which includes no confirmation process, that is, does not obtain confirmation from the real user 10, and the process ends.

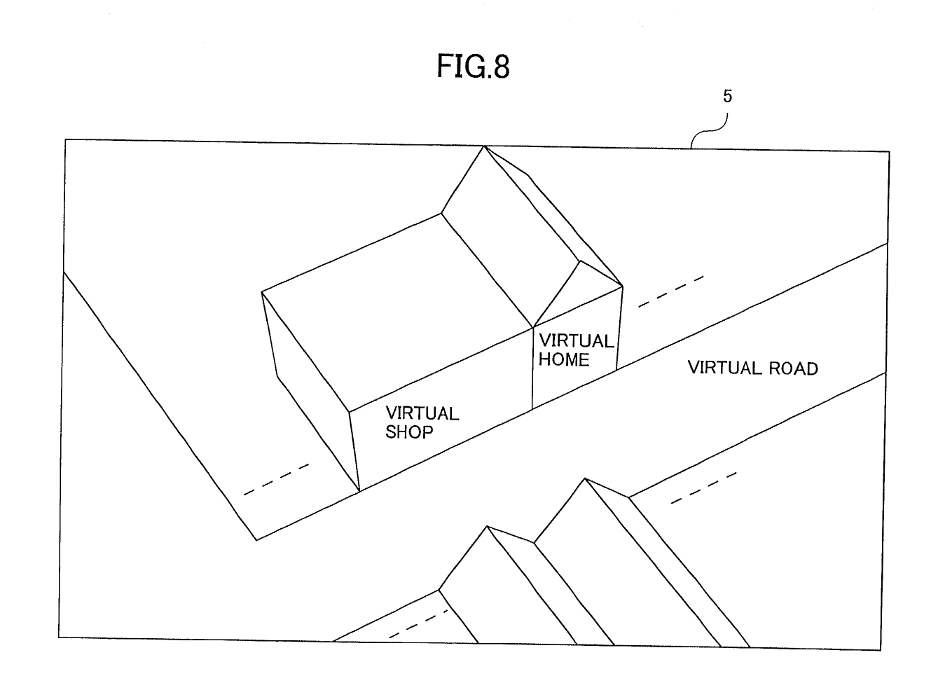

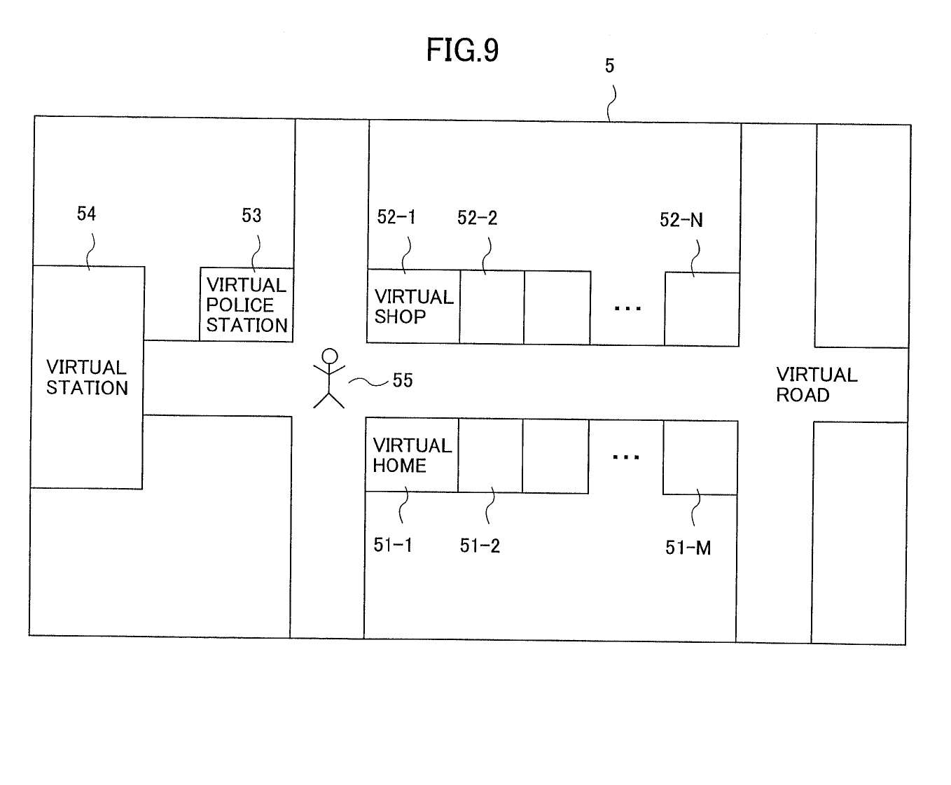

Returning now to the description of FIG. 3, in the server system 21, the virtual city section 22 includes one or a plurality of servers such as Web servers, and provides one or a plurality of virtual cities 5. The virtual city section 22 may display the virtual city 5 in a three-dimensional format shown in FIG. 8 or, in a two-dimensional map format shown in FIG. 9. The display format may be made selectable depending on the communication rate, for example, or may be specified by the virtual user 1, that is, the real user 10.

For example, in a case where the two-dimensional display format shown in FIG. 9 is employed, each of virtual homes 51-1 through 51-M within the virtual city 5 corresponds to a virtual address of a virtual individual and is an entrance to a homepage of the virtual individual. Each of virtual shops 52-1 through 52-N within the virtual city 5 corresponds to an entrance to a homepage of the virtual shop. A virtual police station 53 is an entrance to a homepage of a window which is managed by the manager 6 and is usable when a problem is generated or a guide to a predetermined virtual shop or the like is requested. A virtual station 54 is an entrance to an address list of the virtual cities, and is usable when moving to another virtual city.

Instead of a cursor, it is possible to display a character 55 of the virtual individual who is accessing the virtual city 5. In this case, the position of the character 55 may be displayed in real-time, similarly to an existing role-playing game. Accordingly, when a salesperson of the virtual shop comes out, it is possible for the character 55 to make a conversation with the salesperson in real-time.

In the server system 21, the approval section 23 approves the access via the Internet 2, approves the dial-up connection, monitors an unauthorized access within the virtual city 5, controls the communication via the firewall 3, and makes a virus-scan. The approval of the access via the Internet 2 and the approval of the dial-up connection can respectively be made by known approval (authentication) methods. For example, it is possible to deny access to the virtual city 5 unless the transaction password of the virtual individual is input, prohibit use of the virtual bank account within the virtual city 5 unless the bank transaction personal ID number of the virtual individual is input, and prohibit use of the virtual credit card within the virtual city 5 unless the personal ID number of the virtual credit card of the virtual individual is input. By making such approvals, it becomes possible for the virtual individual who is registered to the manager 6 to access the virtual city 5 from an arbitrary access point, while maintaining security.

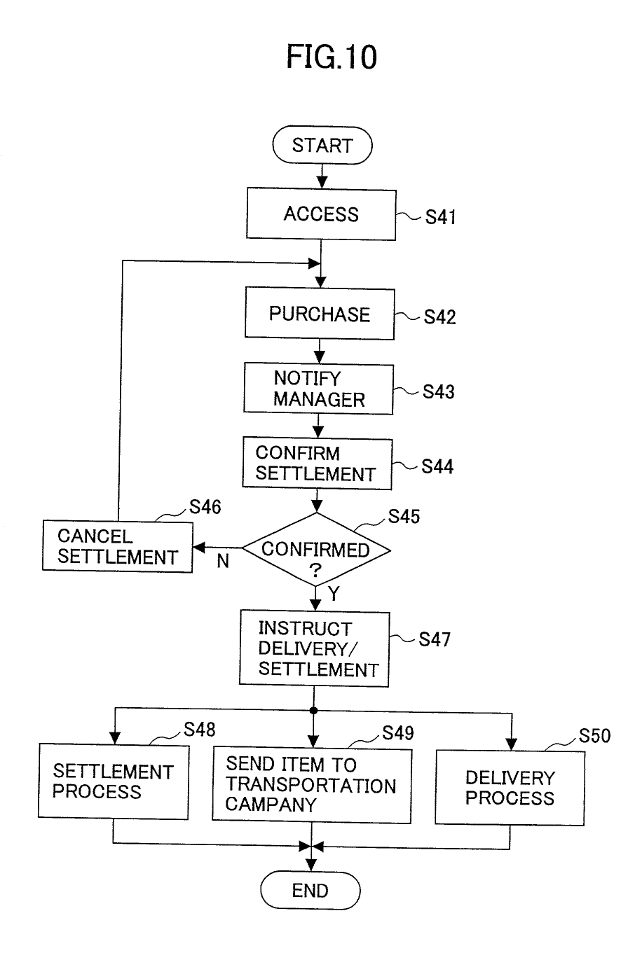

Next, a description will be given of a procedure for a particular case where a virtual individual purchases an item at a virtual shop within a virtual city, by referring to FIGS. 1, 3, 9 and 10. FIG. 10 is a flow chart for explaining the operation of this first embodiment.

Log-In:

In a step S41 shown in FIG. 10, the virtual user 1 inputs a log-in password, for example, and an address “ABC@DEF” of the virtual city 5, from a terminal at an arbitrary access point, so as to make access to the virtual city 5 via the Internet 2 and the firewall 3. As a result, the virtual city 5 shown in FIG. 9 is displayed on the terminal of the virtual user 1.

Item Purchase:

In a step S42, the virtual user 1 selects a virtual shop 52-1 within the virtual city 5, for example, and carries out a purchasing procedure after selecting the item which is to be purchased. First, the virtual user 1 inputs the transaction password for making a transaction within the virtual city 5, the virtual name of the virtual user 1, the virtual address of the virtual user 1, the virtual bank account number or the virtual credit card number and the corresponding personal ID number, the settlement method and the like.

At the virtual shop 52-1, that is, at the organization (or company) which provides the virtual city 5, a step S43 notifies to the manager 6 at least the virtual name of the virtual user 1, the virtual bank account number or the virtual credit card number and the corresponding personal ID number, the settlement method and the like which are received, together with the amount of purchase.

Confirmation of Approval of Settlement:

In a step S44, the manager 6 confirms the approval of the settlement to the real user 10, based on the information notified from the virtual shop 52-1. The confirmation method is not limited to a particular method. For example, the manager 6 automatically contacts the portable telephone of the real user 10, and obtains the confirmation on the approval of the settlement from the portable telephone. From the portable telephone of the real user 10, the confirmation may be made by voice, inputs made from buttons of the portable telephone, electronic mail and the like. In a step S45, the manager 6 decides whether or not the confirmation is obtained on the approval of the settlement. If the manager 6 cannot obtain confirmation on the approval of the settlement and the decision result in the step S45 is NO, the manager 6 cancels the settlement process and notifies the virtual user 1 accordingly in a step S46, and the process returns to the step S42.

On the other hand, if the manager 6 obtains the confirmation on the approval of the settlement and the decision result in the step S45 is YES, the manager 6 notifies the virtual shop 52-1 accordingly, notifies the financial company 8 of the information which is necessary for making the settlement, including the real personal information, and notifies the transportation company 9 of the information which is necessary for delivering the purchased item, including the real personal information, in a step S47. The financial company 8 makes the settlement in the real world with respect to the purchased item by the specified method in a step S48.

Delivery of Item:

When the virtual shop 52-1 is notified of the confirmation on the approval of the settlement from the manager 6, the virtual shop 52-1 sends the purchased item to the transportation company 9 in a step S49. The transportation company 9 delivers the purchased item to the real address of the real user 10, based on the information notified from the manager 6, in a step S50. The steps S48, S49 and S50 are carried out in parallel, and the process ends.

Next, a description will be given of a second embodiment of the electronic commercial transaction method according to the present invention. This second embodiment of the electronic commercial transaction method employs a second embodiment of the communication method according to the present invention and a second embodiment of the managing apparatus according to the present invention.

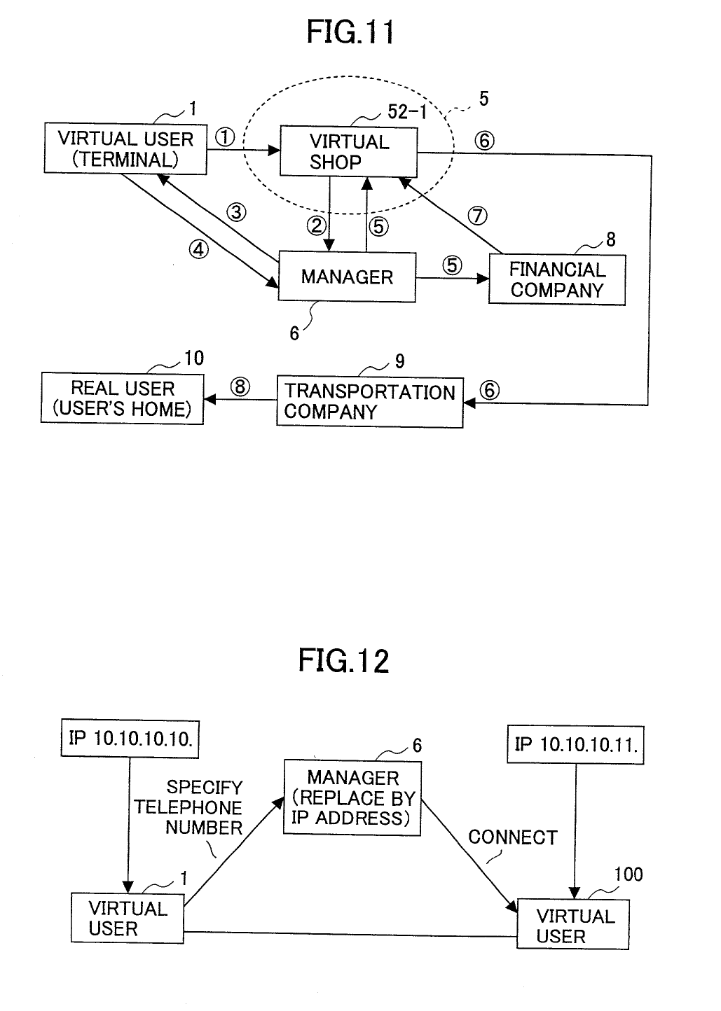

FIG. 11 is a diagram for explaining this second embodiment of the electronic commercial transaction method. In FIG. 11, those parts which are the same as those corresponding parts in FIG. 1 are designated by the same reference numerals, and a description thereof will be omitted. In this embodiment, the virtual personal information is converted into the real personal information in both the financial company 8 and the transportation company 9, but it is of course possible not to make the conversion in one of the financial company 8 and the transportation company 9. The financial company 8 and the transportation company 9 respectively are tied up with the manager 6, and manage at least a portion of the registered information which is managed by the manager 6 and is provided by the manager 6 in advance. Accordingly, the registered information managed by the financial company 8 includes at least information used to convert the information which is necessary to make the settlement, and the registered information managed by the transportation company 9 includes at least information used to convert the information which is necessary to deliver the purchased item.

A description will be given of a procedure of this embodiment for a particular case where the virtual individual purchases an item at a virtual shop within the virtual city. It is assumed for the sake of convenience that the virtual shop 52-1 within the virtual city 5 is a supermarket, and that the virtual user 1 purchases bread from a terminal which is provided at a station.

Step \mathring{1}:

In this step, the virtual user 1 inputs the information which is necessary to shop within the virtual city 5, such as the virtual personal information, and orders the bread to the virtual shop 52-1. For example, the contents of this order include a desired delivery time band for enabling the virtual user 1 to receive the delivered bread.

Step \mathring{2}:

In this step, the virtual shop 52-1 notifies the amount of purchase of the bread to the manager 6, together wit the virtual personal information of the virtual user 1 who made the purchase.

Step \mathring{3}:

In this step, the manager 6 seeks confirmation on the approval of the settlement related to the purchase of the bread to the virtual user 1, based on the information received from the virtual shop 52-1. For example, this confirmation may be sought by contacting the portable telephone of the virtual user 1. The portable telephone may be contacted by calling or by sending an electronic mail.

Step \mathring{4}:

In this step, the virtual user 1 confirms the approval of the settlement related to the purchase of the bread, with respect to the manager 6, from the portable telephone. This confirmation may be made by voice, inputs made from the buttons of the portable telephone, electronic mail and the like.

Step \mathring{5}:

In this step, the manager 6 notifies the confirmation on the approval of the settlement to the virtual shop 52-1 and the financial company 8, in response to the confirmation received from the virtual user 1. The information notified to the financial company 8 includes the virtual personal information which is received by the manager 6 from the virtual shop 52-1.

Step \mathring{6}:

In this step, the virtual shop 52-1 sends the purchased bread to the transportation company 9, based on the confirmation notified from the manager 6, and notifies the virtual personal information to the transportation company 9.

Step \mathring{7}:

This step is carried out by the financial company 8, in parallel with the step \mathring{6} described above. In a case where the financial company 8 is a bank, the virtual personal information is converted into the real personal information, the settlement related to the purchase of the bread is made, the amount of purchase is withdrawn from the actual bank account of the virtual user 1, and the amount of purchase withdrawn is remitted to the virtual shop 52-1. On the other hand, in a case where the financial company 8 is a credit card company, the virtual personal information is converted into the real personal information, the settlement related to the purchase of the bread is made, the amount of purchase is charged (billed) to the real credit card of virtual user 1 with respect to the real user 10, and the amount of purchase charged is remitted to the virtual shop 52-1.

Step \mathring{8}:

In this step, the transportation company 9 converts the virtual personal information into the real personal information, and delivers the purchased bread to the address of the real personal information, that is, the real address of the real user 10, at the specified delivery time band.

Therefore, the user can purchase an item at a virtual shop from an arbitrary access point, and have the purchased item delivered to the user's home or the like. In addition, if the address of the delivery is specified, it is also possible to have the purchased item delivered to an arbitrary address desired by the user. The time of the delivery can also be specified if necessary.

According to this embodiment, the access to the virtual city is made from the terminal provided at the station. However, the access may be made from the portable telephone of the virtual user 1, by using the electronic mail function, the mail function utilizing packet communication, and the Web access service of the portable telephone. Of course, the access may be made from portable terminals or equipments other than the portable telephone. Furthermore, the terminal used at the access point (or access source) is not limited to a portable terminal which is typified by a lap-top personal computer, and various apparatuses may be used, including a desk-top personal computer and a so-called intelligent television set which is provided with the Internet function.

Next, a description will be given of a third embodiment of the communication method according to the present invention. This third embodiment of the communication method employs a third embodiment of the managing apparatus according to the present invention.

FIG. 12 is a diagram for explaining this third embodiment of the communication method. In FIG. 12, those parts which are the same as those corresponding parts in FIG. 1 are designated by the same reference numerals, and a description thereof will be omitted. This third embodiment of the communication method realizes a communication between virtual users using Internet telephones.

In FIG. 12, the manager 6 records an Internet Protocol (IP) address which is assigned when the virtual user 1 makes a log-in to the virtual city 5 via the Internet 2, as in each of the embodiments described above, and links this IP address to a specified telephone number. For example, it is assumed for the sake of convenience that an IP address “10.10.10.10.” is assigned to the virtual user 1 when this virtual user 1 makes the log-in, and an IP address “10.10.10.11.” is assigned to a virtual user 100 when this virtual user 100 makes the log-in. In order to realize a two-way communication between two parties, each party must know the IP address of the other party. However, since the IP address changes every time the connection is made, the two-way communication between the two parties cannot be realized in a simple manner according to the prior art. But in this embodiment, the manager 6 records the IP address of the other party and links this IP address with the specified telephone number. For this reason, when the virtual user 1 inputs the specified telephone number, and the virtual user 1 is once connected to the virtual user 100 via the manager 6, it looks as if the virtual user 1 is directly connected to the virtual user 100, and the two-way communication can be realized in a simple manner between the virtual users 1 and 100.

Therefore, by building the virtual city, the manager can profit from individual membership fees, corporate membership fees, registration fees and the like. In addition, the participants in the virtual city, such as the owners of the virtual shop, can also anticipate increased profit on the Internet due to the improved security and the like. In addition, the financial companies can anticipate increased profits from more active electronic commercial transactions. Moreover, the transportation companies can also anticipate increased profits from increased delivery demands.

On the other hand, the users, that is, the individuals, can also enjoy shopping on the Internet, both safely and with ease. In addition, the users can also participate in net-auctions or the like on the Internet. Hence, the user can purchase living necessaries or the like which are required daily, for example, from the virtual shop on the Internet. The user can also communicate inexpensively using the virtual telephone number in the virtual world.

By building the virtual city, the demands for a high-speed communication network increases, and this may promote completion of the infrastructure in optic fiber communication networks and mobile communication industries. Of course, this may also promote completion of the contents which are provided, such as video and movie downloading services, chat services, and counseling services.

Further, the present invention is not limited to these embodiments, but various variations and modifications may be made without departing from the scope of the present invention.

What is claimed is:

1. A communication method comprising the steps of:
communicating via a network virtual personal information having a representation format similar to that of real personal information of a real world; and
converting the virtual personal information into the real personal information based on registered information, in a managing apparatus provided in the network.

2. An electronic commercial transaction method comprising the step of:
making a commercial transaction in a virtual world on a network, based on virtual personal information received via the network,
said virtual personal information having a representation format similar to that of real personal information of a real world.

3. The electronic commercial transaction method as claimed in claim 2, further comprising the step of:
converting the virtual personal information into the real personal information in a managing apparatus provided in the network.

4. The electronic commercial transaction method as claimed in claim 3, further comprising the step of:
instructing delivery and/or settlement of an item from the managing apparatus depending on the commercial transaction, based on the real personal information.

5. The electronic commercial transaction method as claimed in claim 2, further comprising the step of:
seeking confirmation on an approval of the settlement to an individual in the real world who made the commercial transaction, based on the virtual personal information.

6. The electronic commercial transaction method as claimed in claim 2, further comprising the steps of:
approving log-in to the virtual world; and
approving the commercial transaction in the virtual world.

7. The electronic commercial transaction method as claimed in claim 6, wherein said step of approving the log-in and said step of approving the commercial transaction respectively approve based solely on the virtual personal information.

8. The electronic commercial transaction method as claimed in claim 2, wherein said virtual personal information includes at least one of a virtual name, a virtual address in a virtual city within the virtual world, a virtual telephone number, a virtual bank account number of a virtual bank within the virtual city, and a virtual credit card number of a virtual credit card usable in the virtual world.

9. A managing apparatus comprising:
managing means for managing registered information which is used when converting virtual personal information into real personal information of a real world, said virtual personal information having a representation format similar to that of the real personal information; and
converting means for converting the virtual personal information received via a network into corresponding real personal information of the real world, based on the registered information.

10. The managing apparatus as claimed in claim 9, further comprising:
means for instructing delivery and/or settlement of an item depending on a commercial transaction which is made in a virtual world in which the virtual personal information is used, based on the real personal information.

11. The managing apparatus as claimed in claim 9, further comprising:
means for seeking confirmation on an approval of a settlement to an individual in the real world who made a commercial transaction in a virtual world in which the virtual personal information is used, based on the virtual personal information.

12. A virtual city space comprising:
a plurality of virtual shops accessible via a network,
a commercial transaction being made between a first virtual individual and an arbitrary one of the virtual shops, based on virtual personal information of the first virtual individual,
said virtual personal information having a representation format similar to that of real personal information of a real world.

13. The virtual city space as claimed in claim 12, further comprising:
a virtual home of a second virtual individual having a virtual address in the virtual city space,
a communication being made between the first virtual individual and the second virtual individual, based on the virtual personal information of the first virtual individual.

14. The virtual city space as claimed in claim 13, further comprising:
a virtual station through which the first virtual individual can move to another virtual city space.

15. The virtual city space as claimed in claim 12, further comprising:
a virtual station through which the first virtual individual can move to another virtual city space.
